(19) United States
(12) Patent Application Publication
(10) Pub. No.: US 2024/0211147 A1
(43) Pub. Date: Jun. 27, 2024

(54) SELF PROTECTING DIGITAL ASSETS

(71) Applicant: Keyavi Data Corp., Durango, CO (US)

(72) Inventors: Shai GUDAY, Durango, CO (US); Elliot Daniel LEWIS, Durango, CO (US)

(21) Appl. No.: 18/522,187

(22) Filed: Nov. 28, 2023

Related U.S. Application Data
(63) Continuation-in-part of application No. 17/482,010, filed on Sep. 22, 2021.
(60) Provisional application No. 63/428,388, filed on Nov. 28, 2022.
(60) Provisional application No. 63/081,763, filed on Sep. 22, 2020.

(51) Int. Cl. G06F 3/06

(52) U.S. Cl. CPC G06F 3/0623; G06F 3/0655; G06F 3/0673

(57) ABSTRACT

A method implements self protecting digital assets. The method includes receiving a digital asset identifier corresponding to a digital asset. The method further includes converting the digital asset identifier to an encrypted file. The method further includes storing the encrypted file to nonvolatile memory. The method further includes accessing the digital asset using the encrypted file.

### CROSS REFERENCE TO RELATED APPLICATIONS

This application claims the benefit of U.S. Provisional Application 63/428,388, filed Nov. 28, 2022, which is incorporated by reference herein. This application is a continuation in part of U.S. patent application Ser. No. 17/482,010, filed Sep. 22, 2021, which is incorporated by reference herein. U.S. patent application Ser. No. 17/482,010 claims the benefit of U.S. Provisional Application 63/081,763, filed Sep. 22, 2020, which is incorporated by reference herein.

### BRIEF DESCRIPTION OF DRAWINGS

FIG. 1, FIG. 2A, and FIG. 2B illustrate examples of methods in accordance with the disclosure.

FIG. 3, FIG. 4, and FIG. 5 illustrate further examples of embodiments of the disclosure.

FIG. 6 illustrates a further example of embodiments of the disclosure.

Similar elements in the various figures are denoted by similar names and reference numerals. The features, elements, methods, etc., described in one figure may extend to and be used by similarly named features, elements, methods, etc., in different figures.

### DETAILED DESCRIPTION

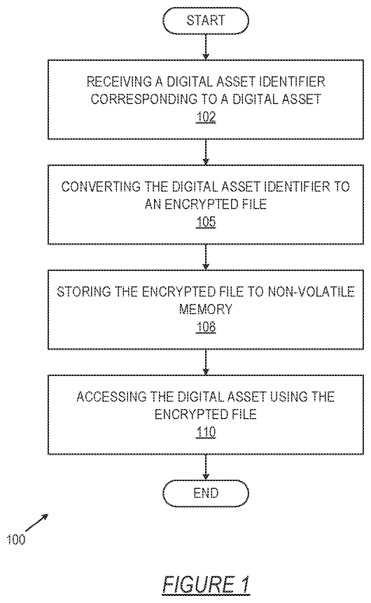

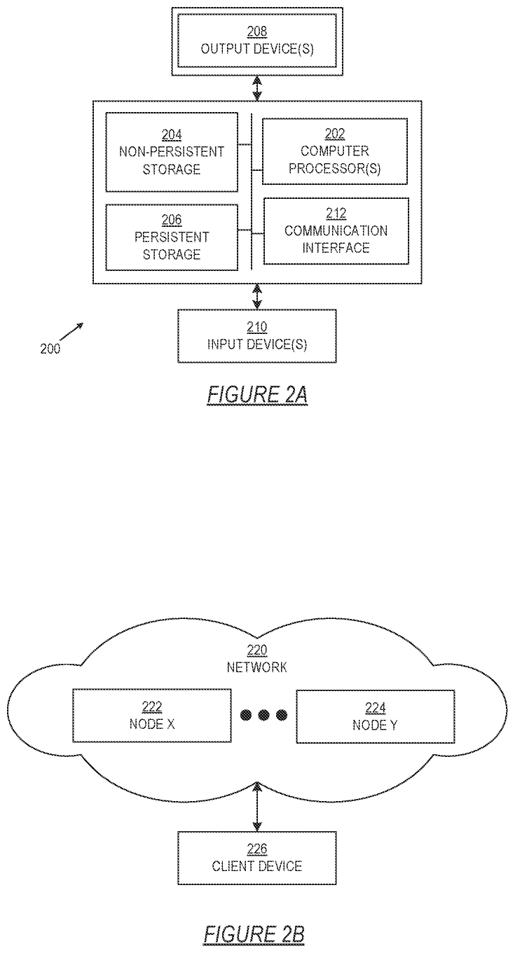

Turning to FIG. 1, the process (100) may execute using one or more computing systems. For example, the process (100) may execute on a server communicating with a user device.

At Step 102, a digital asset identifier is received that corresponds to a digital asset. In one embodiment, the digital asset may be an amount of cryptocurrency, a smart contract, a nonfungible token (NFT), etc. The digital asset identifier may be received from an exchange application. The exchange application may be a web service used by multiple users to exchange digital assets. The digital asset identifier may be received in a message from a server.

At Step 105, the digital asset identifier is converted to an encrypted file. The encrypted file protects the digital asset identifier and underlying digital asset from being used by wrongful parties. In one embodiment the encrypted file may be in accordance with one or more of the encrypted file (202) of FIG. 2 of U.S. Provisional Application 63/081,763, filed Sep. 22, 2020, and the encrypted file (200) of FIG. 2 of U.S. application Ser. No. 17/482,010, filed Sep. 22, 2021.

At Step 108, the encrypted file is stored to nonvolatile memory. The encrypted file may be stored to one or multiple devices since the underlying digital asset is protected by the use of the encrypted file. For example, if a user were to copy the original digital asset identifier to multiple devices, wrongful parties may be able to access the digital asset using the digital asset identifier. In contrast, copying the encrypted file to multiple devices does not run the risk of wrongful parties accessing the digital asset since the encrypted file by itself cannot be used to access the digital asset.

At Step 110, the digital asset is accessed using the encrypted file. In one embodiment, one or more portions of the encrypted file are decrypted in a protected space of volatile memory. The digital asset may be accessed with the digital asset identifier that is unencrypted in nonvolatile memory. In order to decrypt the encrypted file, an authorization process is performed to determine that the decryption is by a rightful party. The authorization process may verify a user by location with geofencing, verify a username, verify a password, etc.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 2A, the computing system (200) may include one or more computer processors (202), non-persistent storage (204), persistent storage (206), a communication interface (212) (e.g., Bluetooth interface, infrared interface, network interface, optical interface, etc.), and numerous other elements and functionalities that implement the features and elements of the disclosure. The computer processor(s) (202) may be an integrated circuit for processing instructions. The computer processor(s) may be one or more cores or micro-cores of a processor. The computer processor(s) (202) includes one or more processors. The one or more processors may include a central processing unit (CPU), a graphics processing unit (GPU), a tensor processing unit (TPU), combinations thereof, etc.

The input devices (210) may include a touchscreen, keyboard, mouse, microphone, touchpad, electronic pen, or any other type of input device. The input devices (210) may receive inputs from a user that are responsive to data and messages presented by the output devices (208). The inputs may include text input, audio input, video input, etc., which may be processed and transmitted by the computing system (200) in accordance with the disclosure. The communication interface (212) may include an integrated circuit for connecting the computing system (200) to a network (not shown) (e.g., a local area network (LAN), a wide area network (WAN) such as the Internet, mobile network, or any other type of network) and/or to another device, such as another computing device.

Further, the output devices (208) may include a display device, a printer, external storage, or any other output device. One or more of the output devices may be the same or different from the input device(s). The input and output device(s) may be locally or remotely connected to the computer processor(s) (202). Many different types of computing systems exist, and the aforementioned input and output device(s) may take other forms. The output devices (208) may display data and messages that are transmitted and received by the computing system (200). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (200) in FIG. 2A may be connected to or be a part of a network. For example, as shown in FIG. 2B, the network (220) may include multiple nodes (e.g., node X (222), node Y (224)). Each node may correspond to a computing system, such as the computing system shown in FIG. 2A, or a group of nodes combined may correspond to the computing system shown in Figure A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (200) may be located at a remote location and connected to the other elements over a network.

The nodes (e.g., node X (222), node Y (224)) in the network (220) may be configured to provide services for a client device (226), including receiving requests and transmitting responses to the client device (226). For example, the nodes may be part of a cloud computing system. The client device (226) may be a computing system, such as the computing system shown in FIG. 2A. Further, the client device (226) may include and/or perform all or a portion of one or more embodiments of the invention.

The computing system of FIG. 2A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

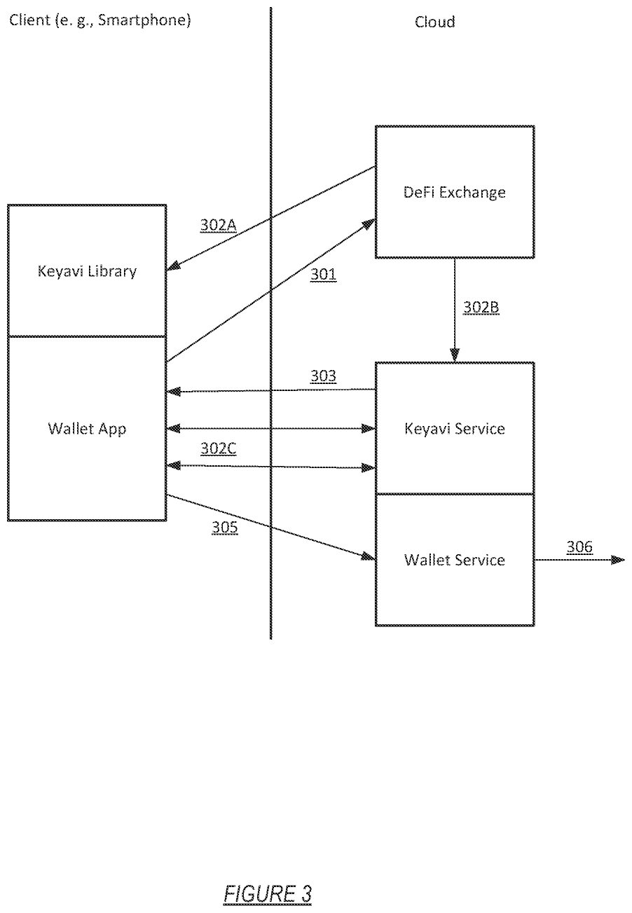

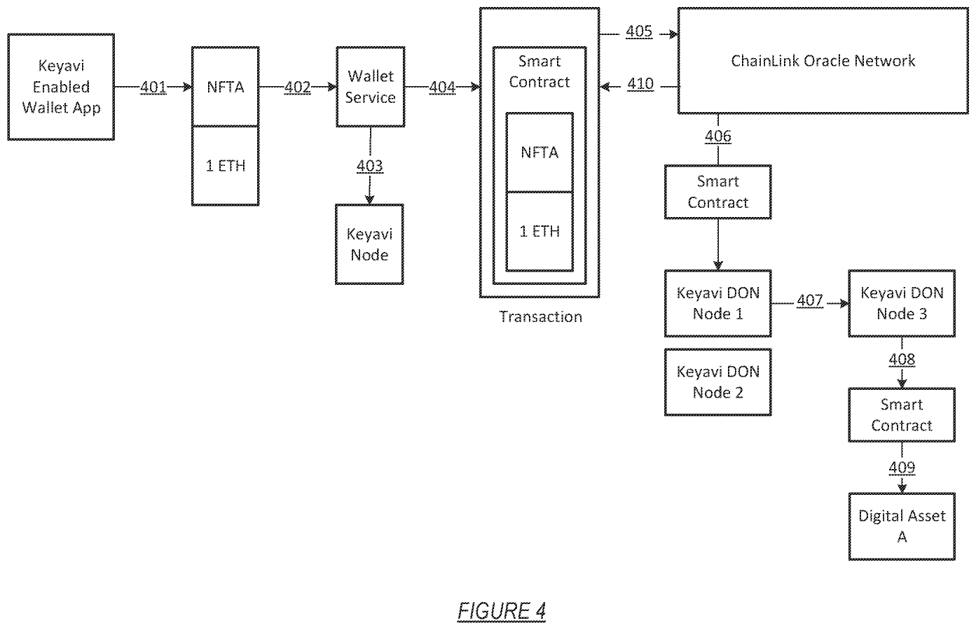

FIG. 3, FIG. 4, and FIG. 5 illustrate further examples of embodiments of the disclosure.

Systems and methods deliver Keyavi components for self-protecting data for cryptocurrency and digital asset ownership.

Systems and methods include mechanism for the protection of cryptocurrency wallet data, both for custodial exchanges and decentralized wallet services.

Systems and methods may secure smart contracts by federating Keyavi nodes to provide decentralized oracle networks that may be used to enable the execution of secured smart contracts.

Systems and methods may tie the ability to access a digital asset to the ownership of a nonfungible token (NFT) that represents the digital asset.

Cryptocurrency assets are constantly under attack as high value targets for cyber thieves. When cryptocurrency is issued, a key pair is created, one of which is public and the other which is private. In a typical custodial wallet for cryptocurrency, the exchange holds the private key internally and may only make it available to the user when the user wishes to withdraw their assets from the exchange. If the exchange utilizes Keyavi to secure the private key of the account, even if that key is exfiltrated from the exchange, the Keyavi protected key may be unusable outside of the exchange. By protecting the session authentication token that the exchange issues to the user, the exchange may leverage Keyavi to ensure that the access is in accordance with certain policies, e.g., specific devices, geolocations, user identities, and time of day, etc.

A wallet service of a decentralized finance exchange may also be used, where experts recommend not leaving more than a threshold amount of digital assets in the “hot wallet”. If keys to the wallet are lost, then the funds represent by the keys may be irrevocably unavailable. The funds may continue to exist, but no entity may be able to conduct any transaction with them. A different strategy is to store the private key for a cryptocurrency on secured thumb or disk drives. Such storage introduces fear and doubt to the mass market and introduces friction to the process of exchanging crypto currency between accounts. Such issues may be addressed by allowing the wallet service to use Keyavi components to protect the private keys as the private keys are issued. The user may backup the protected data anywhere in the cloud without worrying about the ability of an attacker to access the funds.

In the cryptocurrency space the concept of Smart Contracts (SC) has evolved and may be used on public blockchains (e.g., the Ethereum blockchain). Smart contracts include lines of code that may implement self-executing contracts with the terms of the agreement between buyer and seller. The code of smart contracts may exist across a distributed, decentralized blockchain network. The code controls the execution, and transactions are trackable and irreversible. A challenge is that the terms of a smart contract may not be accessible to each user of a blockchain. Another challenge is that smart contracts may be executable by any node on the network, which limits the scope and type of terms that may be included in the contract. For example, certain types of smart contracts may not be calculated by every node as since the smart contract may utilize data that is not accessible across the network. Decentralized oracle networks (DONs) may address these issues. Decentralized oracle networks may act as a middleman between applications using blockchains. Decentralized oracle networks may include a group of dispersed nodes (e.g., servers referred to as oracles) that gather data from the real world, from multiple sources and add the data to the blockchain. Using Keyavi components (e.g., applications and services) may enable a subset of decentralized oracle network nodes to be federated, allowing the nodes to discover one another. Protection provided by Keyavi components may be used on top of smart contracts to ensure that the contract terms are private, the execution is private, and that the smart contract is protected.

With a Keyavi protected decentralized oracle network, the protection from using Keyavi components may be applied to smart contracts dealing with the trading of nonfungible tokens. Nonfungible tokens may be traded using a smart contract in which the transaction details are published to a public ledger. Which nonfungible token was acquired and for how much, as well as any other terms are publicly available. Additionally, the party that acquired the nonfungible token may have no assurance that the asset is no longer available to the selling party. Keyavi components may be used to protect the digital asset at the time of the creation of the nonfungible token, protect the private key of the nonfungible token, and assign the ownership of the asset and the nonfungible token private key to the creator.

Turning to FIG. 3, for the case of a DeFi wallet, the user may purchase the cryptocurrency from a DeFi exchange (301).

The DeFi exchange transfers the private and public keys for the crypto purchase to the user's wallet application (302a). If that occurs, then the wallet app may request Keyavi protection before storing the keys (302c) and protect the keys locally.

Alternatively, the DeFi exchange might transfer the keys to the wallet service for their immediate protection (302b), at which point the Wallet service might provide the Keyavi protected private Key to the Wallet App (303).

When the user intends to transact a Keyavi protected coin, the user may request the Keyavi service to access the private key (304) and post a transaction (305) after signing the transaction with the private key.

The wallet service may execute the transaction on a public blockchain (306) (e.g., the Ethereum blockchain).

In the diagram below, shown is a flow for a smart contract where an ownership property of the asset is bound to the nonfungible token.

This example utilizes a custodial exchange but applies equally for both a custodial and DeFi wallet-based transaction.

Turning to FIG. 4, the user creates a proposed smart contract (401) requesting to acquire a Keyavi protected nonfungible token hosted on a nonfungible token exchange 3, and the asset A for 1 ETH coin binding the two operations together in a smart contract (402).

The service utilizes a Keyavi node to protect the terms of the smart contract (403).

The transaction is written to the ledger; however, the smart contract now contains a subsection of Keyavi protected data with a callout to the Keyavi decentralized oracle network (404).

Any node on the public chain may access the smart contract but may be unable to complete it, having to call out to the decentralized oracle network for execution (405).

The chain link oracle network detects the callout and routes the smart contract for execution to any Keyavi node in the decentralized oracle network (406).

In this case node 1 picks up the protected smart contract but it may not execute it as node 1 does not control the asset A. Instead, through federation node 1 routes the smart contract to the controlling node (as determined by the Keyavi tuple which it may access, and which contains the entity and node id of the Keyavi node that is being targeted (407).

Node 3 is able to parse the contract (408) on behalf of the owner of asset A, and transfers ownership of the asset A to the new owner (409).

At that point the Keyavi enabled decentralized oracle network node 3 is able to report back and sign an attestation that the smart contract purchase has been fulfilled, with the nonfungible token and ETH transactions having been written to the public decentralized network ledger, and the asset ownership transferred (410).

The decentralized network may attest to that and mark the contract as having been completed (411).

Turning to FIG. 5, utilizing Keyavi components as a part of the system (500) may implement protections on a one-by-one basis for digital assets, smart contracts, transactions, etc.

For the DeFi case, Keyavi protected private keys provide a robust secure mechanism that may also deliver a forensic audit trail for the account. The use of Keyavi protected keys allows the user to share key access with others, e.g., brokers, for a time duration or window of their choosing without worrying about the broker having access to the actual key.

The use of Keyavi protected terms for a smart contract provides critical privacy, which some decentralized oracle networks may enable today, but also allows for the dynamic interactions of both custodial and DeFi service providers with the blockchain while securing the data and smart contract terms.

Keyavi components used with smart contracts provides the capability to support tying digital asset access to an actual nonfungible token that represents that asset. The functionality provided by the use of Keyavi components may further encompass properties for “limited signed editions”, or “fractional ownership” for digital assets.

Keyavi components may be used with applications that include cryptocurrency trading, as well as digital asset trading where digital assets could include audio, video, or other media as well as data files (e.g., title to a home or vehicle).

The systems according with the disclosure may have participating exchanges each deploy a corresponding Keyavi node. The nodes may be loosely federated, which provides for a Keyavi protected data item being sent to each of the nodes to find the Keyavi node that controls the access to the data item.

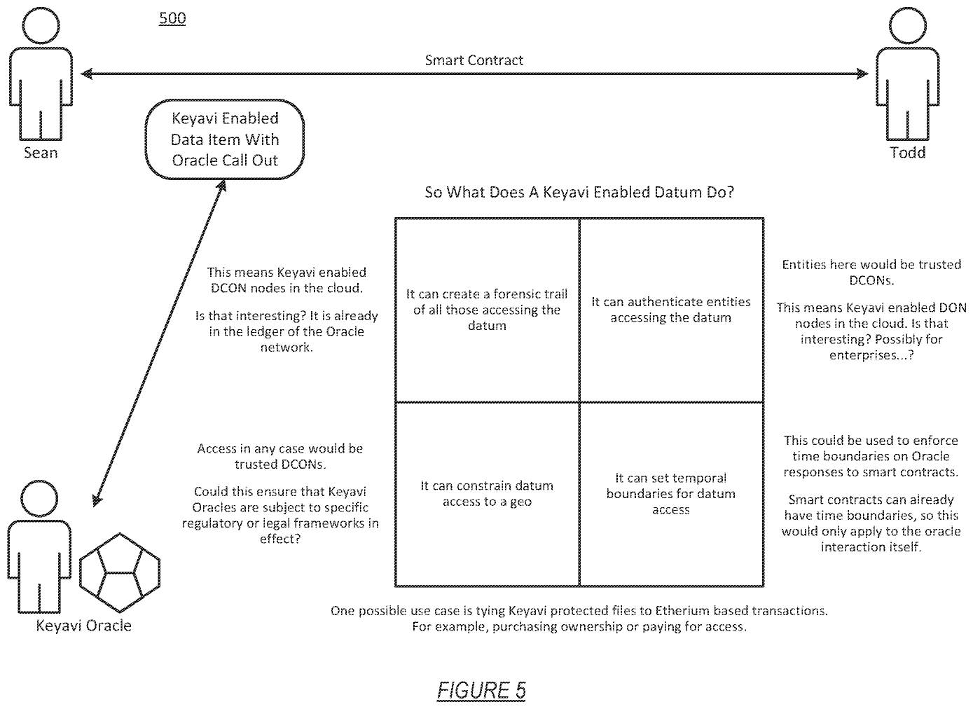

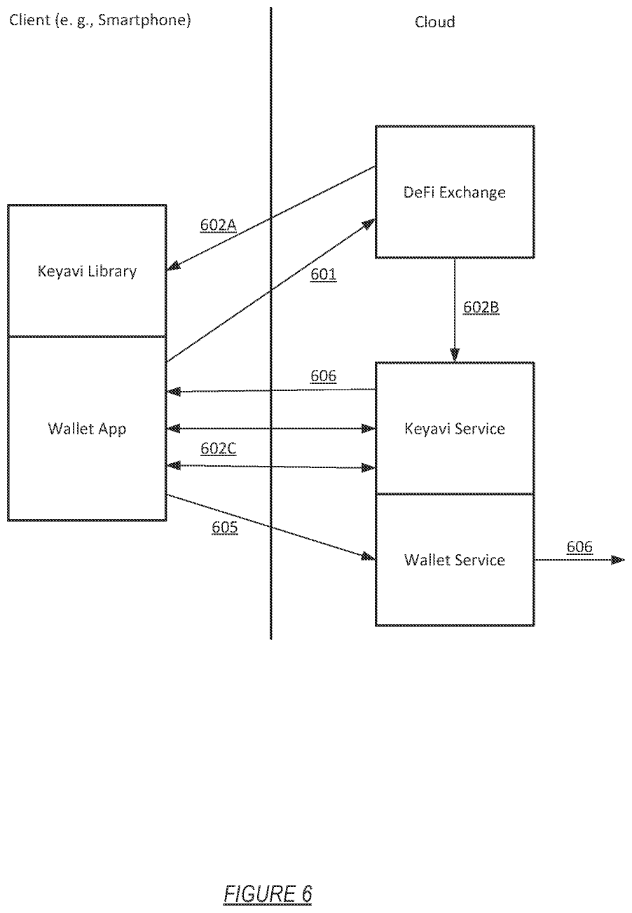

FIG. 6 illustrates a further example of embodiments of the disclosure.

Keyavi software components (Keyavi components) ensure that data is protected from the onset without requiring that the data be “shipped” to a service for its protection, or for subsequent access. In the case of cryptocurrency, as an example, the private key can be thought of as data that can be protected by Keyavi components.

In the diagram above, in stage (601) User A may create a crypto currency account with a DeFi exchange and acquiring cryptocurrency using their wallet application or a browser.

The acquisition results in the creation of a public key and a corresponding private key pair being transmitted by the exchange over HTTP SSL (602a).

While the transport is secure, the private key, used to access the funds and sign transactions, is generally not encrypted and may often be stored in the browser cache. This is a threat since it may be possible to access the key if stored in that manner.

In other implementations the wallet application on the client may secure the private key and use a device specific key store (e.g., Samsung Knox) to store the private key value while on the device. The challenge here is that if the user wants to access the cryptocurrency from more than one device, the private key is again be sent across a secure transport in an unencrypted manner.

By integrating the Keyavi client library of the Keyavi components with the client wallet, the key may be protected by the Keyavi components the moment the key arrives prior to any storage.

A request to a Keyavi service (presumably tied to the wallet service) is made (602c) and a keypac (a key package of the Keyavi components) provided by the

Keyavi service (603) can be used to protect the private key data while in memory. The keypac contains the encryption keys along with the specific policies that get applied and stored in a microDB. The key is protected by using the keypac with the key to generate an encrypted file. The protected key (i.e., the encrypted file) may then be stored locally, shared among devices, backed up in online cloud storage systems, etc., without fear of loss.

When the user wishes to transact using the private key, a call can be made to the Keyavi node servicing their wallet for the keypac, at which point the wallet app can access the private key, sign the transaction (605), and allow the wallet service to post the transaction to the ledger (606).

Note that in some implementations the exchange may utilize its own Keyavi node and thus protect the public/private key pairs from the moment of creation (602b). This could further leverage the federation model mentioned below and allow the exchanges to protect the crypto assets from the moment of creation/purchase, prior to any transmission, and still work seamlessly with any Keyavi enabled wallet service that the user happens to utilize.

The Keyavi protected keys also possess additional properties which help secure them:
1. The policies may constrain access to the keys to a particular device or set of devices.
2. The policies may allow a user to grant read access to other users, e.g. a broker.
3. The policies may constrain access to times of day
4. The policies may require location service enablement and disallow any VPN or TOR tunnels that may serve to mask the user's location.
5. All access is logged and a full audit trail maintained in real time in perpetuity by the system for attempts to access the protected keys, or to change policies and permissions that are applied to them.
6. This forensic data is available both as logs that can be exported and via APIs that can be used to integrate SIEM and AI based capabilities to monitor for suspicious activity.
7. Additional policies may be created utilizing any one or more of the multiple parameters that the Keyavi library detects or may easily be extended to. The parameters may include parameters geo-locations, application versions, etc. For example, the keys would not be accessible if a policy was in place to require a minimal version level of the wallet app, and the version being used by the user was not compliant. Similarly, a malware check or a root kit check may be set as policy requirements.

One of the strengths of the Keyavi solution is that the capabilities can be upgraded dynamically on the fly and copies of the data may comply with the modified policies when a user next attempts to access them.

### Geographic Fencing

A Keyavi node is able to maintain a nodal list of geographic areas of two types: geographic zones that are allowed access to the node and geographic zones that are explicitly excluded. These zones apply across users and the data objects the Keyavi nodes protect on their node and today are based upon country or zip code.

With protecting wallets, a comprehensive policy model for geofencing may be included. In some implementations the geofence may consist of a loci and a radius, while in others an arbitrarily sized polygon may be used.

The geofencing functionality may enable geofences to be applied, both for inclusion and exclusion, to an individual wallet (e.g. my private key for a specific cryptocurrency). The geofencing functionality may enable composite layering, enabling users to express constructs such as:
United States-YES
London, UK-YES
World-NO
   Which would not allow access outside of the US or of London.

The geofencing functionality may also introduce a hierarchy, so an exchange may decide that access from North Korea is never permitted, and users are not allowed to override that in their private wallets. This leads to more complex geofencing models where nodes may have geo inclusions, geo exclusions, and advisory fences. An advisory fence may not be enabled by default but allow the users to explicitly enable the advisory fence after displaying a warning. An example may be Ukraine having an advisory fence. A user may be warned about adding the city Kiev in Ukraine, then the user may acknowledge the warning and enable the advisory fence when stability is still at risk.

### Federation

Federation enables Keyavi nodes to interact with one another. The Keyavi tuple that is present in the protected data contains information about the nodeid, the userid and the object id. If the nodeid is anything other than the node's own id, the user attempt to access the data contents fails. Two tiers of federation may be used: internal and external. Both are likely required for scaling out to enable millions of users in the ecosystem to interact.

Internal federation allows a single entity, such as a company or an exchange, to create a “single system image” of Keyavi services across nodes operated by the entity. In this manner, a user from Accounting and a user from Legal can exchange and edit documents that were Keyavi protected on their own department nodes without each having to have accounts for both Accounting and Legal. In the internal federation model, when a user turns to a local node for access, the existing data tuple that identifies the Keyavi node may be expanded to include <unique entity id, node id, userid, fileid>. Within an enterprise, nodes may support redirecting requests to other trusted nodes joined to a listening service while the client remains connected to their “home node”. In this manner, when someone from Accounting tries to access a protected file on the Legal node, and the two maintain a trust relationship that has been previously configured, the Legal node can validate that the user at Accounting has access permission and provide the keypac through the accounting node to the user's client - allowing the user access to the data.

External federation allows multiple entities to collaborate and implement federation by establishing trust relationships between entities, similar to internal federation but at an entity scale. Both forms of federation can exist at the same time. Consider two exchanges, A and B, that are supporting Keyavi smart contracts (SCs). One of the Keyavi exchanges, A, within the decentralized oracle network (DON) would be able to access the entity id of the protected smart contract, and ship the request to B for execution. In the case of crypto, once entity A ships the request, entity A absolves itself of any further role in accessing the smart contract. Keyavi node B in the decentralized oracle network treats the shipped request as a catalyst to begin processing the smart contract. Once the smart contract is completed, node B returns the result to a chainlink ledger, where any node may return the smart contract to a public ledger (e.g., the Ethereum ledger) as having been executed.

Triparty models may also be used. A triparty model may include the case of two wallet services—one per user, and a digital asset management node, which is using Keyavi components to protect the digital asset itself without touching the nonfungible token. In some cases, multiple parties may be engaged, e.g., for the case of smart contracts that are transacting among several nodes to form insurance pools.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a digital asset identifier corresponding to a digital asset;
converting the digital asset identifier to an encrypted file;
storing the encrypted file to nonvolatile memory; and
accessing the digital asset using the encrypted file.

2. A system comprising:
at least one processor; and
an application then, when executed by the at least one processor, performs:
receiving a digital asset identifier corresponding to a digital asset;
converting the digital asset identifier to an encrypted file;
storing the encrypted file to nonvolatile memory; and
accessing the digital asset using the encrypted file.

3. A non-transitory computer readable medium comprising instructions that, when executed by at least one processor, perform:
receiving a digital asset identifier corresponding to a digital asset;
converting the digital asset identifier to an encrypted file;
storing the encrypted file to nonvolatile memory; and
accessing the digital asset using the encrypted file.
